(19) United States
(12) Patent Application Publication
(10) Pub. No.: US 2023/0222421 A1
(43) Pub. Date: Jul. 13, 2023

(54) SYSTEM AND METHOD FOR DYNAMIC OBJECTS AND USES FOR SAME, INCLUDING DYNAMIC CASE MODEL INSTANCES IN A CASE MANAGEMENT SYSTEM

(71) Applicant: OPEN TEXT HOLDINGS, INC., Menlo Park, CA (US)

(72) Inventor: Ashraf Ali Syed, Bangalore South (IN)

(21) Appl. No.: 18/151,785

(22) Filed: Jan. 9, 2023

Related U.S. Application Data
(60) Provisional application No. 63/298,050, filed on Jan. 10, 2022.

(51) Int. Cl. G06Q 10/0633

(52) U.S. Cl. CPC G06Q 10/0633

(57) ABSTRACT

Systems and methods for case management systems adapted to dynamically alter instances of case models during runtime based on events that occur during the lifecycle of that case model instance are disclosed. Embodiments of such systems and methods may allow the dynamic alteration of the hierarchy of case model instances in a case management system without alteration of the underlying case model definition or other instances of that case model.

### RELATED APPLICATIONS

This application claims the benefit of priority under 35 U.S.C. § 119(e) to U.S. Provisional Patent Application No. 63/298,050, entitled “SYSTEM AND METHOD FOR DYNAMIC OBJECTS AND USES FOR SAME, INCLUDING DYNAMIC CASE MODEL INSTANCES IN A CASE MANAGEMENT SYSTEM,” filed Jan. 10, 2022, which is hereby fully incorporated herein by reference for all purposes.

### TECHNICAL FIELD

This disclosure relates generally to dynamic objects associated with a model, definition, or type. In particular, this disclosure relates to dynamic case model instances in a case management system in a distributed networked computing environment. Specifically, embodiments of this disclosure relates to dynamic alteration of the hierarchy of runtime case model instances in a case management system without alteration of the underlying case model definition.

### BACKGROUND

Ever since the advent of the computer networks (including the Internet), enterprise environments have been steadily growing more complicated, encompassing an ever-expanding amount of increasingly complex digital content (or just content). Digital content, in essence, is anything that exists in a binary format that may exist in the enterprise environment or otherwise be utilized by the enterprise. The digital content of an enterprise may thus include a variety of digital assets including text, images, aural or video content, templates used in content delivery, objects, or other types of content. For purposes of this disclosure, the terms document and content will be used interchangeably and understood to have the same definition as digital content.

In an enterprise environment, these documents may be widely distributed and used for a wide variety of purposes in association with that enterprise. One particular type of these systems is a case management system. Case management systems are used to automate the management of complex sets of documents or other content and associated processes comprising tasks that may be performed. One the difficulties in implementing a useful case management system is the definition of complex and useful case models

It is thus desirable to improve the functionality of such case management systems, including with respect to the case models employed by such case management systems.

### SUMMARY

As discussed, documents in an enterprise environment may be widely distributed and used for a wide variety of purposes in association with that enterprise. To aid in managing and using their various documents, many enterprises have employed a number of content management systems, such as digital asset management (DAM) systems, content management systems (CMS), web content management (WCM) systems, enterprise content management (ECM) systems, etc.

One particular type of these systems is a case management system. Case management systems, software, or cloud-based or other electronically-provided case management services (collectively, “case management systems”) are used to automate the management of complex sets of documents or other content and associated processes comprising tasks that may be performed (e.g., utilizing the documents). Thus, these case management systems may be utilized with particular efficacy in situations in which the documents or other content that may need to be managed for respective particular instances of a case model may not be the same for each instance and the processing required or selected to be performed may not be the same for each instance. Case management or management of cases may occur, for example, in many sectors of an entity's operations.

A case can thus be thought of as a project (e.g., a software development project, building design and construction, car model development and manufacturing, patent application creation and prosecution, and other projects), a grouping of related work (e.g., child protective case), or other such collection. A case may involve multiple people to systematically collaborate on a package of content and data in at least a semi-structured way. Examples of such situations include processing loan applications, insurance claims or medical records, though other examples are easily contemplated and may be applied to a wide variety of documents or tasks. To illustrate other examples, case management applications may be suited for organizations like investigative case management (e.g., anti-money laundering, fraud, underwriting, claims management, legal matter management, stormwater management, public defender case management); service request management (e.g., customer onboarding, contract requests, employee onboarding, probationer management, vendor onboarding, provider onboarding); or health care and clinical trials (e.g., new drug approval and clinical trials, patient investigation).

Thus, one of the difficulties in implementing a useful case management system (especially in the case where the case management system may be utilized with a content management platform) is to enable an application builder or domain expert to define a case model comprised of a complex hierarchy of container objects which can be used to categorize, classify, or group organization data objects and arrange them in a tree like structure. Specifically, in many cases, the designers of such case models may desire that the structures of various instances of a case model be altered during the runtime use of a case model based on various circumstances that may occur in the runtime (e.g., as the case model instance goes through a workflow or the like). As such, another related challenge is to make a case model's hierarchy dynamic so it can be modified or altered at runtime with respect to case model instances for various use cases or requirements.

It is thus desirable to improve the functionality of such case management systems with respect to the management of these cases.

To address these ends, among others, embodiments as disclosed herein may allow dynamic objects to be associated with a (e.g., static) model, definition, or type (e.g., used here interchangeably). In particular, this disclosure relates to dynamic case model instances in a case management system in a distributed networked computing environment. Specifically, embodiments of this disclosure relate to dynamic alteration of the hierarchy of runtime case model instances in a case management system without alteration of the underlying case model definition. (e.g., static) model, definition, or type (e.g., used here interchangeably).

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore non-limiting, embodiments illustrated in the drawings, wherein identical reference numerals designate the same components. Note that the features illustrated in the drawings are not necessarily drawn to scale.

FIG. 1A is a flow diagram of one embodiment of a method for case management.

FIG. 1B is a block diagram of one embodiment of a system for case management.

FIG. 2 is a block diagram of one embodiment of a case model definition.

FIG. 3 is a block diagram of one embodiment of a system for case management.

FIG. 4 is a block diagram of one embodiment of a system for case management.

FIG. 5 is a diagrammatic representation of an example of a case model instance.

FIGS. 6 and 7 are block diagrams of embodiments of systems for case management.

FIG. 8 is a diagrammatic representation of an example of a case model instance.

FIG. 9 shows a computing system in accordance with one or more embodiments of the technology.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components, and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions, or rearrangements within the spirit or scope of the underlying inventive concept will become apparent to those skilled in the art from this disclosure.

Before describing embodiments in more detail, some context may prove useful. As discussed, in an enterprise environment, case management systems are used to automate the management of complex sets of documents or other content and associated processes comprising tasks that may be performed. Thus, these case management systems may be utilized with particular efficacy in situations in which the documents or other content that may need to be managed for respective particular instances of a case model may not be the same for each instance and the processing required or selected to be performed may not be the same for each instance.

Accordingly, case management systems may be utilized in situations in which content that may need to be managed for respective particular instances of a case model may not be the same for each instance and the processing required or selected to be performed may not be the same for each instance. Examples of such situations include processing loan applications, insurance claims or medical records, though other examples are easily contemplated and may be applied to a wide variety of documents or tasks. Case management may thus be thought of as a pattern of work common throughout many disciplines that requires a group of people to systematically collaborate using content and associated data.

In these case management systems, a case model typically describes a type of case, instances of which are to be managed by a case management system. A case may be thought of as a way of organizing documents (and, in some instances, the processes that are used to manage those documents). A case model is created at design time to create structure for the case (e.g., model for a set of folders). This structure (e.g., objects) is then created at runtime for an instance of the case when the case model instance is created. For example, the case model definition may include a hierarchical container model portion defining a hierarchical data model representing how case data is organized using a plurality of hierarchically related case nodes.

As opposed to very structured business process that defines a predetermined workflow that does not vary from instance to instance, using a case model one can model ad hoc actions and define responses thereto with workflows, enabling the processing of respective instances of a case model to be determined dynamically at runtime based, e.g., on events, context data, user input, dynamic evaluation of documents or other content, etc. As a result, each instance of a case model (e.g., the respective loan applications of different applicants or each individual employee) may follow its own course as determined at each step by processing (e.g., that may be defined in applicable portions of the case model).

Thus, one of the difficulties in implementing a useful case management system (especially in the case where the case management system may be utilized with a content management platform) is to enable an application builder or domain expert to define a case model comprised of a complex hierarchy of container objects which can be used to categorize, classify, or group data objects and arrange them in a tree like structure. Specifically, in many cases, the designers of such case models may desire that the structures of various instances of a case model be altered during the runtime use of a case model based on various circumstances that may occur in the runtime (e.g., as the case model instance goes through a workflow or the like). As such, another related challenge is to make a case model's hierarchy dynamic so it can be modified or altered at runtime with respect to case model instances for various use cases or requirements.

What is desired, then, are systems and methods that allow case management systems to dynamically alter instances of case models during runtime based on events that occur during the lifecycle or workflow of that case model instance.

To those ends, among others, embodiments of this disclosure relates to dynamic alteration of the hierarchy of runtime case model instances in a case management system without alteration of the underlying case model definition. In one embodiment, embodiments of a case management system may allow the definition of case models that comprise hierarchically related nodes (e.g. nodes related in a tree-structure). In addition, events and associated alteration rules (also referred to as event rules) may be defined with respect to the case type, one or more of nodes of the case model, or data or attributes associated with one or more of the nodes. An alteration rule may include a trigger and an action. The trigger may include a particular event or occurrence with respect to a node or data of a node, while the action may include a configuration definition. The configuration definition may, for example, define, or include code for, the reconfiguration of a case model instance. This reconfiguration may include the removal of nodes of the case model instance or the reconfiguration of relationships between those nodes.

During the runtime then when instances of that case model are created (e.g., as objects in the case management system) and being utilized in the case management system (e.g., being utilized in a workflow, etc.) events may occur in association with that case model instance. When such events occur the alteration rules may be checked to see if any of the triggers of the alteration rule matches the event (e.g., or data associated with the event, etc.). If a trigger for an alteration rule is matched the configuration definition of the alteration rule may be executed and that case model instance dynamically reconfigured based on the configuration definition of the alteration rule. It should be understood here that while embodiments as disclosed herein are described with respect to case management systems, embodiment as discloses may be generally applicable to the dynamic alteration of objects associated with a (e.g., static) model without loss of generality.

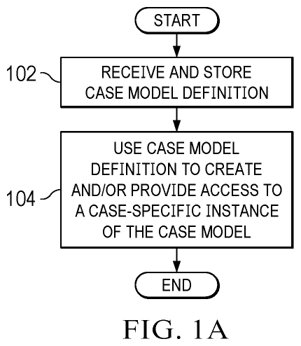

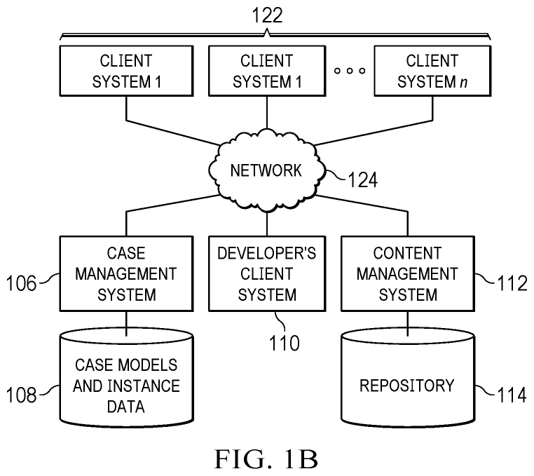

Moving then to FIG. 1, a flow chart illustrating an example embodiment of a process to perform case management is depicted. In the example shown, a case model definition is received and stored (STEP 102). The case model definition (or just case model or type) is used to create new instances based on the case model, sometimes referred to herein as “case instances” or “case management instances”, or to provide access to previously-created instances (STEP 104). For example, a case model may be defined and stored for an employee and an associated process and a loan application and associated processes. Case model instances may be created based on the case model and each respective case instance used to manage a corresponding loan application, for example by different respective loan applicants.

Using a case model, one can model ad hoc actions with smaller processes, for example, as opposed to a very structured process that defines an end-to-end workflow. In various embodiments, a case model comprises a hierarchical/nested container model (sometimes referred to herein as a “hierarchical data model”), and may in addition define case roles, case phases (states), or permissions. In some embodiments, permissions may be defined for each case node or level in the hierarchy, and may vary in some embodiments based at least in part on the respective phases (states) of a state machine defined for a case node.

In various embodiments, a case model may include a hierarchical or nested container model. This model represents how the data within a case is organized and what data is captured during runtime. Each node in the hierarchy is sometimes referred to herein as a “case node”. Case nodes at the lowest level of a case model hierarchy may be referred to as “case leaf nodes” or simply “leaf nodes”. “Case leaf nodes” in various embodiments may point to a specific business object or document type.

In various embodiments, a case model as described herein may be created using a domain-specific or other development module or tool. For example, reusable elements, such sample case nodes typical of those used in the domain (e.g., documents, case roles, behaviors, etc. that may be associated with a an employee, loan application process, a new drug approval application, etc.), primitives usable to define a state machine or associated processing for respective case nodes, etc., may be provided. For example, an application programming interface (API) may be defined, or a visual or other case model development tool may be provided.

A case model definition may be embodied in an eXtensible Markup Language (XML) or other structured data file. A case management system or platform is provided, which is configured (e.g., by software) to load a case model definition, parse the definition, and create an instance of the case model based on the definition. Instance-specific attributes or state information or other metadata may be stored in a case model instance data store (e.g., a database). At runtime, the case model definition file and the case model instance data for a given instance are used by the case management system to implement the case model instance, including by performing processing and managing case model instance associated content per the case model definition, in light of the current values of the case model instance data for that instance.

FIG. 1B is a block diagram illustrating an example embodiment of a case management system and environment. In the example shown, client systems 122 are connected via a network 124 (e.g., the Internet, a LAN, a WAN, a wired, cellular or other wireless network, etc.) to a case management system 106. In various embodiments, the case management system 106 may be configured to implement the process of FIG. 1A. Case management system 106 uses case models stored in data storage 108 to provide case management services with respect to case management instances, the instance variable data values of which also are stored, in this example, in data storage 108. Such data storage 108 may, for example, be in a content management system. For example, one or more of clients 102 may connect via network 104 to case management system 106 to obtain access to case management services. For example, case management system 106 may expose a “case management system as a service” (e.g., as a web service) enabling clients 122 to connect to case management system 106, create case management instances based on case models stored in data storage 108. The users of client system 122 may be prompted to provide data values or other user input to populate case management instances with metadata, user data, documents, etc., or such other user input as may be required to advance case instances through case management processing as defined in the case model.

In the example shown in FIG. 1B, a case model developer system 110 (e.g., a client computer system) also can connect to case management system 106 via network 124. In some embodiments, a case model development user interface or service may be accessed and used to define a case model. For example, a visual or other developer tool may be presented to enable a developer using client system 110 to define a case model and cause the case model to be stored in data storage 108 and deployed by case management system 106. In some embodiments, deployment of a case model includes making the case model available to be used to create case management instances based on the model, and to use the case model to perform with respect to each such instance the case management processing as defined in the case model.

In various embodiments, a case model may indicate one or more content objects to be associated with respective instances of a case model. The case model may include metadata and associated behaviors to enable instance-specific content objects (e.g., documents) to be associated with case leaf nodes of a case instance. In the example shown in FIG. 1B, content objects may be accessed via a content management system 112 configured to manage content objects stored in an associated content repository 114. In various embodiments, case management system 106 may be configured to use instance variables associated with a given case instance and metadata or behaviors defined in an associated case model to interact programmatically with content management system 112 to obtain or manage documents or other content objects associated with a case instance. In some embodiments, case management system 106 may be configured, e.g., via the case model, to invoke services or other functionality of content management system 112 with respect to such documents or other content objects.

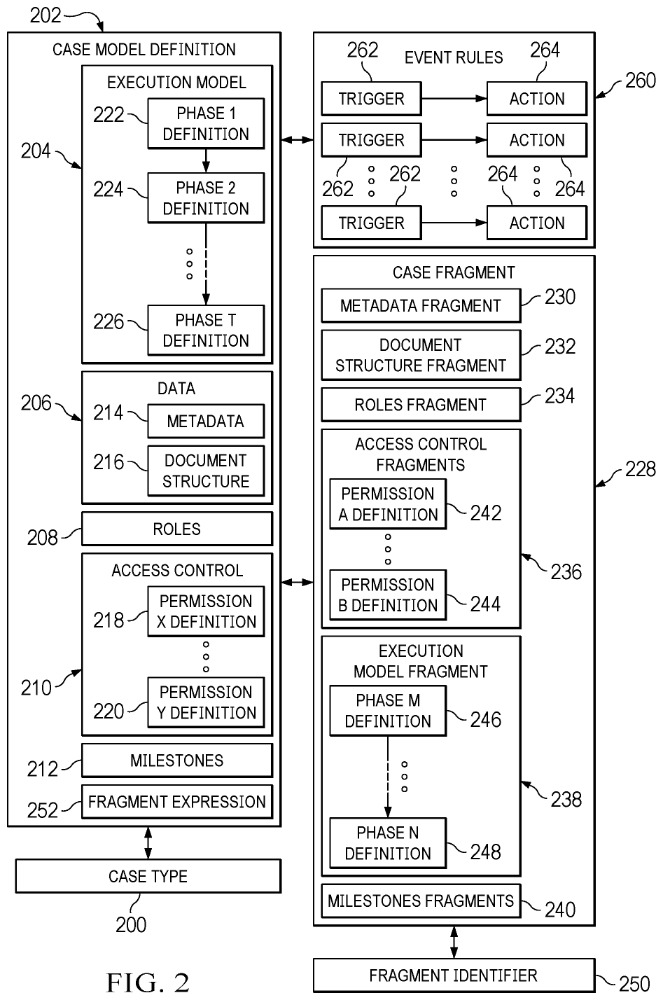

FIG. 2 shows a schematic diagram of a case model definition 202 and case fragments 228 in accordance with one or more embodiments. The case model definition 202 is related to a case type 200. The case type defines the type of case to which the case model definition is applicable. In other words, the case model definition may be defined for each instance of a case having the same case type. By way of an example, the case type may be “utility patent application,” and the case model definition is defined for all utility patent applications involving a particular company and a particular firm. In the example, each instance of the case may be for a unique particular application for a particular technology. By way of another example, the case type may be “Sedan Cars” and the case model definition may be defined for models of an automaker's line that are sedans. In the example, a separate instance of the case may exist for each unique model in the automaker's line of sedans. The case type may be developer defined, and may represent the set of cases that use identical components for a case model definition (e.g., same documentation templates, same phases, etc.) in accordance with one or more embodiments of the technology.

As shown in FIG. 2, the case model definition 202 may include an execution model 204, data 206, roles 208, access control 210, execution model 204, milestones 21), and a fragment expression. The execution model 204 defines the path for executing the case. In other words, the execution model 204 defines how the case is processed. In one or more embodiments, the execution model 204 may span multiple users, software and hardware systems, and multiple companies. Thus, in such embodiments, the case management may include centralized tracking of the execution of the case.

In one or more embodiments of the technology, the execution model 204 includes a phase definition (e.g., phase 1 definition 222, phase 2 definition 224, phase T definition 226) for each phase of execution. The phase definition defines parameters of the phase. In other words, the phase defines the stage of the case at a particular moment in time. In one or more embodiments, the case may be in only one phase at a time. Further, the phases may be defined linearly in one or more embodiments. In other words, in such embodiments, only a failure in the case may result in the case being reverted back to a prior phase. By way of an example, the phases of a software development project may include inception (e.g., project planning and gathering requirements), elaboration (e.g., architecting the design and performing low level collaboration), construction (e.g., analysis, implementation of the design, and testing), hardening (correcting errors and performing additional testing), and transition (e.g., deployment or release of the software development project). In one or more embodiments of the technology, the phases are defined in the case model definition as phase definitions.

Each phase definition may include parameters, such as the phase identifier, the triggering events to transition to the next phase, deadlines, the roles of users in the phase, and the operations performed in the phase. The deadlines may be defined relatively, such as relative to the start of the case or start of the phase. In one or more embodiments of the technology, the operations may be defined generically in the phase definition.

The data 206 includes data that is stored in a data repository (not shown) for the case. For example, the data 206 may include metadata 214 and document structure 216. Metadata is information about the case that may be used for tracking purposes. For example, the metadata may include fields for maintaining information about status, current phase (discussed below), case administrative data, role memberships, milestones, project instances acting on a case, ad hoc tasks, behaviors and policies, a list of related cases, and sub-cases. The case administrative data may include overall information about the case, such as Case number, Title/Subject of the case, and other such information. The role memberships indicate which users are members of which roles (discussed below) as the roles relate to the case. The status may be a single identifier indicating the current state of the case. The various states of the case may be dependent on the type of case and may be user defined. The current phase maintains a phase identifier of the phase of the case at a present time.

The document structure 216 is a hierarchy that identifies the types of documents and stores templates for the types of documents used in a case having the case type 200. For example, the document structure 216 may have a root node, case nodes that are intermediate nodes in the hierarchy, and leaf nodes that do not have children in the hierarchy. The root node is for the case. Case nodes that are direct children of the root node may be defined for sub-cases and for the main part of the case that are not sub-cases. The main part may include direct children nodes that each correspond to different phases of the case. In other words, the different phases of the case may have distinct documents that are generated for the phase. Each phase may have a sub-hierarchy for the phase. In some embodiments, the document structure may also include information about the objects used for the case.

Continuing with FIG. 2, the roles 208 define the relationships of users to the case. In the case model definition 202, the roles are placeholders for various positions of the users in the case. For a case instance, the roles may be populated with a unique user identifier. Users may correspond to individual humans or to collections of humans. For example, a collection may be a company (e.g., supplier, distributor, vendor), a department of a company, or other collection. Roles may be used to define security and processes for the case. Example roles for a software development case model definition may be Project Manager Role, Architect Role, Team Lead Role, and Engineers Role. In one or more embodiments of the technology, roles may be defined hierarchically, such that roles may include sub-roles.

The case model definition 202 may further include access control definitions 210. Access control definitions define access to elements of a case and may be defined in terms of roles. In one or more embodiments of the technology, the access control definitions 210 may include permission definitions (e.g., permission X definition 218, permission Y definition 220). A permission definition (e.g., permission X definition 218, permission Y definition 220) defines a permission level for a set of circumstances. For example, a permission definition (e.g., permission X definition 218, permission Y definition 220) may relate parameters of the permission with each other. For example, the parameters related to by the permission definition (e.g., permission X definition 218, permission Y definition 220) may include the type of access allowed, the target of the access, the one or more role(s) that are permitted the access, the phase in which the access is allowed, and other such information. In one or more embodiments, permission definitions may be defined hierarchically. The parent permission definition (e.g., permission X definition 218, permission Y definition 220) may provide default values for any parameter of a child. Thus, if a child permission definition has an undefined parameter, the parameter may be defined in the parent.

In one or more embodiments, the case model definition 202 and case fragments 228 are stored in a data repository (not shown). In one or more embodiments of the technology, the data repository is any type of storage unit or device (e.g., a file system, database, collection of tables, or any other storage mechanism) for storing data. Further, the data repository may include multiple different storage units or devices. The multiple different storage units or devices may or may not be of the same type or located at the same physical site.

In one or more embodiments of the technology, milestones 212 are events that may occur in a case. The milestone definition in the case model definition 202 defines the type of milestones to achieve in the case. For example, the milestones may be the creation of the case, a phase transition, a phase completion, the completion of a document in a phase, the approval of a document in a phase, and other milestones. Milestones may be defined time based and/or may include a time parameter for achieving the milestones. Further, milestones may be created at design time or at runtime.

In one or more embodiments, although not shown in FIG. 2, the case model definition 202 may include one or more sub-case definitions. A sub-case definition is a case model definition that is a part of a parent case model definition. In other words, processing of a complex parent case may be partitioned into sub-cases, where the sub-cases have separate roles, access controls, execution models, etc.

In one or more embodiments of the technology, a case fragment 228 is a portion of a case model definition that is separately maintained and may be individually referenced by multiple case model definitions (e.g., case model definition 202). Thus, the fragment expression may include one or more of the following: all or part of metadata for a case (e.g., metadata fragment 230), all or part of a document structure (e.g., document structure fragment 232), all or part of a roles definition (e.g., roles fragment 234), all or part of an access control definition (e.g., access control definition fragment 236), all or part of an execution model (e.g., execution model fragment 238), and all or part of the milestones (e.g., milestone fragments 240). For example, for an access control fragment 236, the case fragment may include a strict subset of permission definitions (e.g., permission definitions (e.g., permission A definition 242, permission B definition 244) for a case. For example, the subset may be for particular roles, or other aspects. By way of another example, the execution model fragment may include only a strict subset of the phase definitions (e.g., phase definitions (e.g., phase M definition 246, phase N definition 248). In at least some embodiments, a case fragment is different from a case model definition in that the case fragment may be incorporated in the case model definition, and define only a portion of a case model definition. In other words, in isolation, a case fragment (228) is an incomplete definition of a case model. Although FIG. 2 shows a single case fragment, multiple case fragments may be defined in the case model definition.

Each case fragment 228 may have a corresponding unique fragment identifier 250 in accordance with one or more embodiments of the technology. The fragment identifier 250 uniquely identifies the fragment in the set of possible fragments. For example, the fragment identifier 250 may be an alphanumeric identifier.

The case model definition 202 may additionally include a fragment expression 252. A fragment expression 252 is an expression for selecting a case fragment (e.g., case fragment (228) from the set of case fragments. In particular, a fragment expression 252 is a function on data from one or more data sources that maps the data to an identifier of a case fragment (e.g., fragment identifier 250). The fragment expression 252 may include references to one or more data sources and describe one or more operations to perform on data from the one or more data sources. The data sources may be inline sources (e.g., graphical user interface widgets, tasks and events, roles and permissions, metadata such as originator of the case, deadlines to complete the case, and any other source of data), context information for the case (e.g., environmental information, such as originating company, user identifier of a user, and any other state information describing the processing environment of the case). In other embodiments, the fragment expression may be a simple assignment operation (e.g., case fragment=fragment identifier 1234). Regardless of whether the fragment expression is a function of data sources, the output of the fragment expression is an identifier of a case fragment.

Although FIG. 2 shows the fragment expression as external to the various components of the case model expression, one or more case fragment expressions may be defined within a component of a case model definition. For example, if a case fragment only includes permission definitions (e.g., permission definitions (e.g., permission A definition 242, permission B definition 244), the access control definition 210 may include the corresponding case fragment expression that references the case fragment. Similarly, a case fragment that only includes a document structure fragment may have a corresponding case fragment expression in the node of the document structure 216 to which the document structure fragment is to be added. Thus, the case fragment expression may be defined in various portions of a case.

A case model definition 202 may also be associated with (e.g., include or reference) one or more alteration rules (also referred to as event rules) 260. These alteration rules 260 may be defined with respect to the case model 202 for the case type 200, data 206 of the case model, such as one or more of nodes of the document structure 216 of the case model, or data or attributes associated with one or more of those nodes. An alteration rule 260 may include a trigger 262 and an action 264. The trigger 260 may include almost any event, data or occurrence that may present with respect to an (e.g., instance of the) case model 200 as that instance is being utilized or processed by a case management system during the runtime. Similarly, the action 264 may define any steps or actions it is desired to perform in association with (e.g., instance of the) case model 200. For example, the action may define or include code for a configuration definition. The configuration definition may, for example, define, or include code for, the reconfiguration of a case model instance. This reconfiguration may include the removal of nodes of the case model instance or the reconfiguration of relationships between those nodes.

As discussed, a case model developer system can connect to a case management system to define a case model and cause the case model to be stored and deployed by the case management system. In some embodiments, deployment of a case model includes making the case model available to be used to create case management instances based on the model, and to use the case model to perform with respect to each such instance the case management processing as defined in the case model. Specifically, a case model may indicate one or more content objects to be associated with respective instances of a case model. The case model may include metadata and associated behaviors to enable instance-specific content objects (e.g., documents) to be associated with case leaf nodes of a case instance.

In some embodiments then, content objects may be accessed via a content management system configured to manage content objects stored in an associated content repository. In various embodiments, the case management system may be configured to use instance variables associated with a given case instance and metadata or behaviors defined in an associated case model to interact programmatically with the content management system to obtain or manage documents or other content objects associated with a case instance. In some embodiments, case management systems may be configured, (e.g., via the case model,) to invoke services or other functionality of content management system 112 with respect to such documents or other content objects.

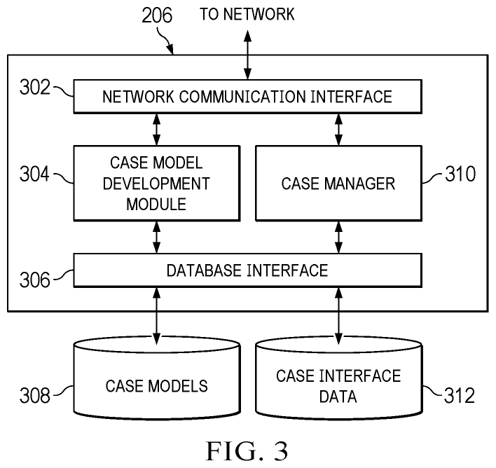

FIG. 3 is a block diagram illustrating an example embodiment of a case management system. In some embodiments, the case management system of FIG. 3 corresponds to case management system 106 of FIG. 1B. In the example shown, case management system 206 includes a network communication interface 302, such as a wireless or other network interface card, to provide network connectivity, e.g., to network 224 of FIG. 1B. A case model development module 304 is accessible to developers via network communication interface 302 and may be used to create or modify case model definitions. In some embodiments, a visual or other user interface is provided, via network communication interface 302, to enable case models to be created or modified. For example, a developer may use a browser to access the developer user interface in some embodiments. Case model definitions are stored by case model development module 304 by using a backend database (or other data storage) interface 306 to store the case model(s) in case model store 308.

Referring further to FIG. 3, the case management system includes a case management module 310. In various embodiments, case management module 310 includes functionality to enable users, e.g., users of client systems to create or use case management instances based on case models stored in case model store 308. Case management module 310, for example, may expose a web or other interface to remote users and may receive via said interface a request to create or access a case instance. Case management module 310 uses database interface 306 to obtain an associated case model definition from case model store 308, to use the case model to instantiate case instances. Instance variables are stored by case management module 310 in case instance data store 312. This case instance data store 312 may, for example, include

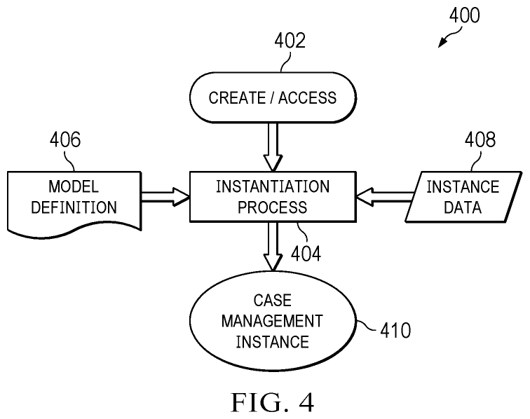

FIG. 4 is a diagram illustrating an example embodiment of a process and system to create or provide access to case management instances. In some embodiments, the process of FIG. 4 may be implemented by a case management system or a component thereof, such as case manager 310 of FIG. 3. In the example shown, case management system 400 receives a request 402 to create or access a case management instance and invokes instantiation process 404. Instantiation process 404 uses a case model definition 406 associated with the request, e.g., a case model indicated explicitly or otherwise associated with data comprising the request 402, and case management instance data 408 associated with the case management instance, to instantiate and provide access to a case management instance 410.

In various embodiments, a case model definition such as model definition 406 may include an XML file or other structured data, which the case management system is configured to parse and use to construct case instances based on the case model. For example, the hierarchical data structure may be defined, along with metadata and associated behaviors for each case node. A case management instance, such as case management instance 410, may include an in memory instance of a data structure defined in case model definition 406, which is used to store instance variables, such as instance data 408 in this example.

As can be seen then, using a case model one can model ad hoc actions and define responses thereto, enabling the processing of respective instances of a case model to be determined dynamically at runtime based, e.g., on events, context data, user input, dynamic evaluation of documents or other content, etc. As a result, each instance of a case model (e.g., the respective loan applications of different applicants or each individual employee) may follow its own course as determined at each step by processing (e.g., that may be defined in applicable portions of the case model).

As mentioned, the data (e.g., objects) for a case model instance (e.g. a runtime instance) may thus be stored in a content management system associated with the case model system. Additionally, in memory instances of the data structures defined by a case model may also be used. These data structures may be referred to as runtime objects or the like, and in one embodiment may be Java objects or the like created in the runtime. Thus, in some embodiments, when a case model instance is created from a case model a set of objects or other representations of the instance may be created in an instance data store such as a content management system. Additionally, runtime objects for the case model instance may also be created. By having these runtime objects the data of the case model instance may be more readily accessed, updated, altered or otherwise processed. In some embodiments the objects or data related to a case model instance in the content management system and in the runtime may be synchronized at some point or substantially continuously.

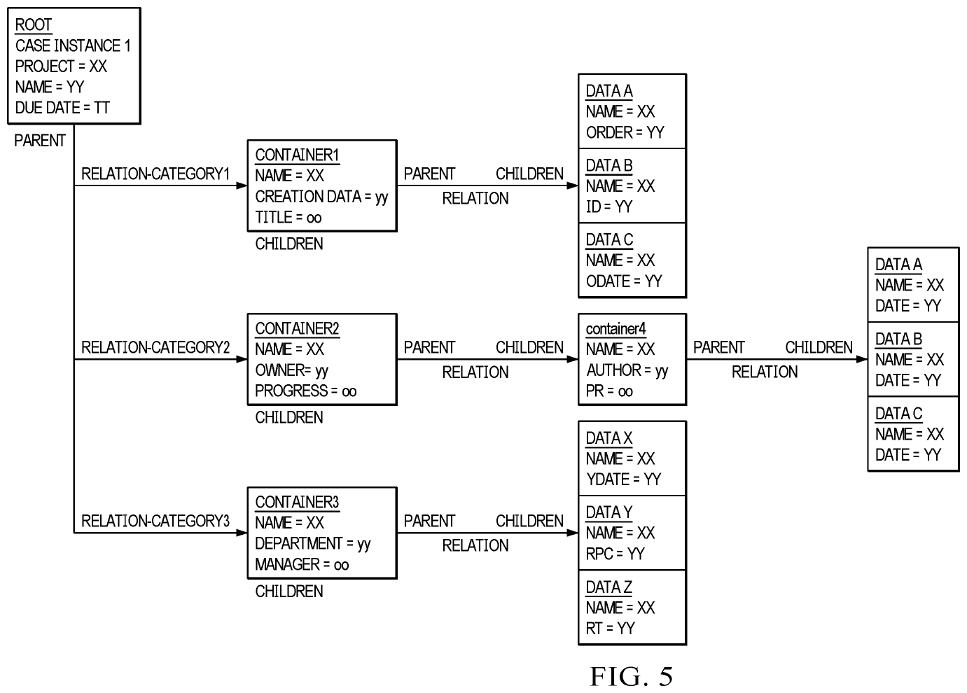

It may be useful here to discuss these case model instances. Looking at FIG. 5 then, a block diagram representing an example of one embodiment of a set of objects for a case model instance is depicted. A hierarchical case object data model may be a persistent object data model in which the objects are arranged in a hierarchical tree-like structure. In hierarchical case object data model, there is a root object which is a container object and contains one or more child container objects. These child container objects can further contain more child container objects or other data objects. The data objects can have only one parent container object. Both container objects and data objects are related to one another in one-to-many relationship using relation objects.

In embodiments of the hierarchical case object data model, both container objects and data objects can have properties of primitive types to hold data. It is initiated from the root container. The accesses to each container and data objects can be controlled using permission sets as discussed. The data objects can be accessed from top to bottom or bottom to top. The relation objects can also have properties of primitive types. These properties can be used to hold relationship related data or can also be used to categorize, classify, and group data based on relationship.

In particular, FIG. 5 depicts a case object model where the hierarchy is started from the root container object. It has three child container objects which are linked with the root object using relation objects. These relation objects can also be used to group or categorize child container objects or data objects. The child container objects are again linked to data objects using relation objects. According to certain embodiments then, as discussed, a hierarchical case object data model can be configured with multiple rules-based events. These events can be designed to alter the hierarchy of the case data model runtime instance dynamically based on these rules.

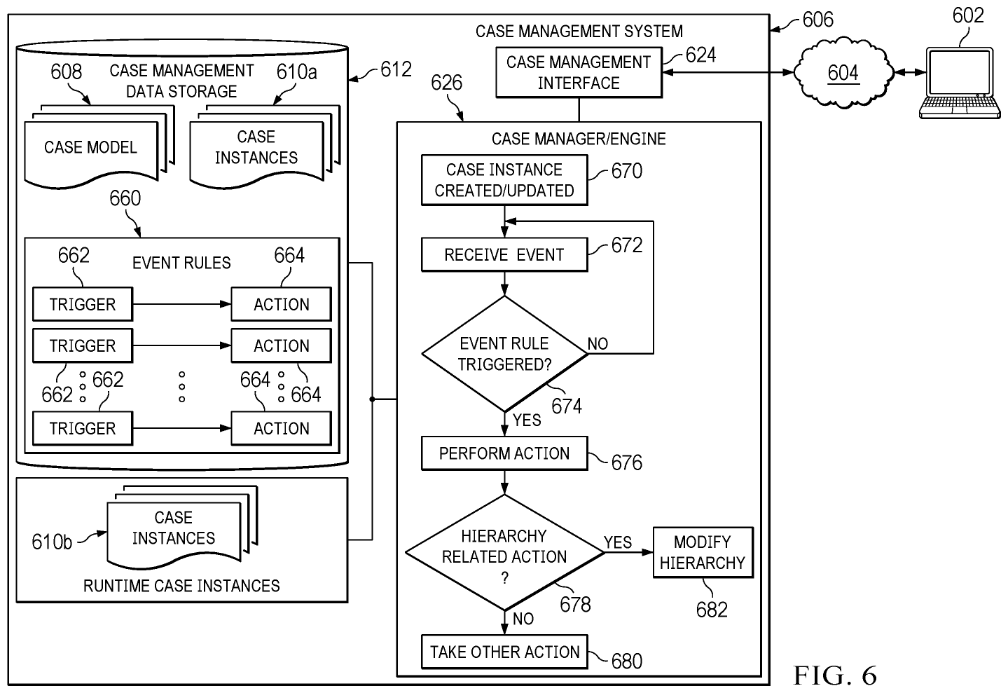

FIG. 6 depicts one embodiment of a case management system adapted to dynamically alter the hierarchy of case model instances. In the embodiment shown in FIG. 6A, client systems 602 are connected via a network 604 (e.g., the Internet, a LAN, a WAN, a wired, cellular or other wireless network, etc.) to a case management system 606. Case management system 606 uses case models (e.g., a definition of a case model) 608 to provide case management services with respect to case instances 610 that include the stored instance variable data values for that case instance. For example, one or more of clients 602 may connect via network 604 to case management system 606 to obtain access to case management services.

In one embodiment, case management system 606 may expose a case management interface 624 (e.g., as a web service, a browser based interface, a graphical user interface, etc.) adapted to allow users at clients 602 to interact with case management system 606 to define case models 608 or associated data and to create or interact with case management instances 610. The case management interface 624 may interface with case manager (including a case engine) 626 to enable users at client system 602 to define case models 608 or create or use case instances 610 based on case models 608. Case models 608 and certain case instances 610 may be stored in case management data store 612. In one embodiment, case management data store may be at a content management system (e.g., may be stored in a portion of a data store residing at a continent management system) or may comprise a continent management system.

To illustrate in more detail In various embodiments, a case model definition such as model definition 608 may include an XML file or other structured data, which the case management system is configured to parse and use to construct case instances 610 based on the case model. A case model definition 608 may also be associated with (e.g., include or reference) one or more event rules 660. These alteration rules 660 may be defined with respect to a case model 608, particular data of the case model 608, such as one or more of nodes of the document structure of the case model, or data or attributes associated with one or more of those nodes of the case model structure as defined in the case model 608. These event rules 660 may be defined separately from the case model 608 and referenced by the case model 608 (or a portion of the case model 608) or may be integrated into the case model 608 itself. For example, the XML of the case model definition 608 may include one or more nodes or tags defining each event rule 660 associated with that case model definition 608.

Each event rule 660 may include a trigger 662 and an action 664. The trigger 660 may include almost any event, data or occurrence that may present with respect to a (e.g., instance of the) case model 608 as that instance is being utilized or processed by case management system 606 during the runtime. Similarly, the action 664 may define any steps or actions it is desired to perform in association with (e.g., instance of the) case model 608. For example, the action may define or include a hierarchy related action. Such a hierarchy related action may include a configuration definition which may include code or other definition. The configuration definition may, for example, define or include code for, the reconfiguration of (e.g. a hierarchy of) a related case model instance 610. This reconfiguration may include the removal of nodes of the case model instance 610 or the reconfiguration of relationships between those nodes.

Accordingly, users at client devices 602 (e.g. through client applications, a browser based interface, etc.) may interact with case management interface 624 (e.g., as a web service, a browser based interface, a graphical user interface, etc.) to define a case model 608 with one or more associated event rules 660, where at least one of those event rules 660 comprises a hierarchy related action 664 adapted to cause a reconfiguration of the hierarchy of a case model instance 610 (e.g., the reconfiguration of the nodes, or objects representing those nodes, or the case model instance 610) created from the associated case model 608. Again, this case model 608 may include an XML file or other structured data defining the hierarchy of nodes of a case model instance 610 created from that case model 608.

Users (e.g., human or non-human users such as applications or the like) at client devices 602 may also interact with case management interface 624 to create, use, or otherwise interact with case model instances 610 (STEP 670). Additionally, case model instances 610 of case models 608 may be created based on an interaction received at case manager 624 from an application or system (e.g., in the course of a workflow or other processing of the application or system). Specifically, when a request or other interaction indicates that a case model instance 610 should be created from a case model 608, the case management interface 624 may interface with case manager (including a case engine) 626 to create a case instance 610 based on a specified or referenced case model 608. Case manager 626 may thus, in response to a request received through the case management interface 624, obtain an associated case model 608 to use the case model 608 to instantiate a case instance 610. Instance variables may be stored, accessed and manipulated in the case instance 610 by the case manager 626. For example, a hierarchical data structure may be defined as a case instance 610, along with metadata and associated behaviors for each case node defined in the XML file.

In one embodiment, there may be two case instances 610a, 610b for a particular case instance 610 created from the case model 608. A case instance 610a stored in the case management data store 612 (a data store case model instance) and a runtime case model instance 610b. Specifically, when a case instance 610 is created from a case model 608 the case manager 626 may obtain the case model 608 and parse the XML of the case model 608 to create associated representations of the nodes of the XML of the case model 608 in the case management data store 612. For example, entries in tables may be created corresponding to the hierarchical case data model representing the root node, all the child containers, the relationships between the nodes of the case model and the data associated with each of the nodes. In some embodiments, the case model instance 610a may include or reference the event rules 660 associated with the case model 608 from which that case model instance 610a was created.

To assist in manipulating or interacting with the case model instance 610a an additional runtime case model instance 610b may also be created. This runtime case model instance 610b may be an in memory instance of the data structures defined by a case model 608. These data structures may be referred to as runtime objects or the like, and in one embodiment may be Java objects or the like created in the runtime. Thus the runtime case model instance 610b may be a hierarchically related set of objects for each node of the case model 608 including a root object which is a container object including one or more child container objects. These child container objects can further contain more child container objects or other data objects. Both container objects and data objects may be related to one another in one-to-many relationship using relation objects. In some embodiments, the objects of the case model instance 610b may include or reference the event rules 660 associated with the case model 608 from which that case model instance 610b was created.

Accordingly, the case manager 626 may interact with (modify, delete, update, process, etc.) the runtime case model instance 610b and any changes may be propagated (either synchronously or asynchronously) to the case model instance 610a in the case management data store 612. As such, as the case instance 610 is utilized (e.g., in processing, workflows, etc.) by case management systems, events associated with that case model instance 610 may be received through the case management interface 624 (STEP 672). The events may have case model instance-specific attributes or state information, be associated with a step in a workflow or process, be associated with a particular user or group, or other defining features (e.g., characteristic, or other attributes).

When such events are received (STEP 672), the case engine of the case manager 626 can determine if the case model instance 610 associated with the received event is associated with any event rules 660 and if any of those event rules are triggered by the received event (STEP 674). Such a determination may be made by accessing the event rules 660 referenced (directly or indirectly through the associated case model definition 608), or included, in the case model instance 610 associated with the event. For each event rule 660 associated with the case model instance 610 associated with the received event, the case engine of the case manager 626 can determine if that event rule 660 has been triggered by matching the conditions (e.g., attributes, data, etc.) associated with the event to the conditions defined by the trigger 662 of that event rule 660.

If an event rule 660 has been triggered (Y Branch of STEP 674) (e.g., the conditions defined by the trigger of the event rule 660 match the features of the received event or the case model instance 610) the action 664 defined by the triggered event rule 660 may be taken by the case engine of the case manager 626 (STEP 676). If the action 664 is not a hierarchy related action If the (N branch of STEP 678) the action may be performed (STEP 680). However, if the action 664 defined by the event rule 660 is a hierarchy related action (Y branch of STEP 678) the case engine of the case manager 626 may modify the hierarchy of the case instance 610 associated with event (STEP 682). Such a modification may include, for example, modifying the hierarchy of the case instance 610 (e.g., such that it is different from than hierarchy as defined by the associated case model definition 608 from which the case model instance 610 was created), including modifying the relationships between nodes of the case instance, or adding or removing nodes (or sub-nodes) to the case model instance 610.

Specifically, in one embodiment, the case management engine of the case manager 624 may modify the objects of the runtime case model instance 610b to modify the hierarchy of the case instance and any changes may be propagated (either synchronously or asynchronously) to the case model instance 610a in the case management data store 612. These modifications to the runtime case instance 610b may include modifications to the root object which is a container object and contains one or more child container objects, the child container objects or any other child container objects or other data objects, or the relationship objected relating the container objects to one another in a one-to-many relationship or other type of relationship. Accordingly, the case manager 626 may interact with (modify, delete, update, process, etc.) the runtime case model instance 610b.

In this manner the hierarchy of the actual case model instances 610 being manipulated by the case management system 606 and undergoing workflows, lifecycles, etc. in association with case management system 606 may have their hierarchy dynamically and independently altered during the runtime according to events specifically defined in association with that case model definition 608 without either affecting the underlying case model definition 608 itself or any other case model instances 610, including those case model instances 610 created from that same case model definition 608. Thus, case model instances 610 created from the same case model definition 608 may have hierarchies different both from the original case model definition 608 and from one another while still being managed in accordance with their association with case model definition 608.

It will be noted here that while embodiments as disclosed herein have been described in condition with the receiving of events through the case manager interface of a case management system, it will be appreciated that such events or occurrences may occur during the use or processing of a case model instance (e.g., in the absence of an event received through the case manager interface) and that such occurrences of case events or conditions meeting may likewise result in the triggering of an event rule 660 and the performance of an action 664 of the rule (including a hierarchy related action) in such instances. Thus, events and conditions occurring (e.g., internally, or as a result of processing of a case model instance 610 by a case management system 606) may also be utilized to dynamically reconfigure the hierarchy of a case model instance 610 (e.g., even in the absence of external events or user input). Additionally, such events may be received from (or generated based on events received from or performed by) other computing systems or applications, including third party computing systems or applications.

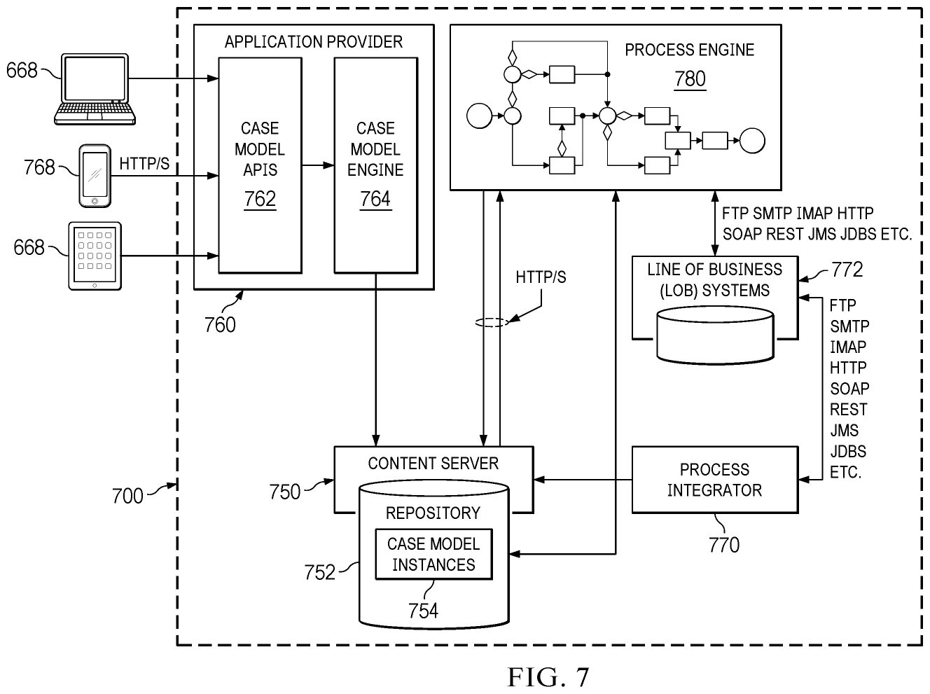

FIG. 7 depicts one specific implementation of an architecture for an embodiment of a case management system. In the embodiment depicted, the architecture of a case management system 700 comprises a content server 750 having a data repository 752 where case model instances 754 are stored. The case management system 700 may also include an application provider 760 that can provide one or more case model interfaces such as case model APIs 762. Case model engine 764 may be adapted to allow a user to design a case model or interact with a case model or case model instance 754 using case model APIs 662. For example, if a request is received to create a case model instance 754 for a particular case model, the case model engine 754 may create objects defined in that case model for the case model instance 754 in the repository 752 with hierarchies and relations as defined in the case model. The case model engine 764 may also maintain runtime case model instances that are memory instances of case model instances 754 at the content server 750.

Process integrator 770 may provide an interface between line of business (LOB) or other types of systems in an enterprise (collectively LOB systems 772), and components of case management system 700 such as process engine 780 or content server 750. The process integrator 770 may communicate according to a number of protocols, such as FTM, SMTP IMAP, HTTP, SOAP, REST, such that events or other communications from the LOB systems 772 (or applications running thereon) can be received at the case management system 700. Case management system 700 may also communicate data (e.g., document, events, etc.) to the LOB systems 772. The case management system 700 may communicate this data to the LOB system 772 according to a number of protocols, such as FTM, SMTP IMAP, HTTP, SOAP, REST. For example, the content management system 700 may upload a document into a specified repository at an LOB system 772 or take other actions during the processing of a case model instance 754.

Process engine 780 may thus be adapted to receive events or other data associated with a case model instance 754 from process integrator 770, case model engine 754 or content server 750. The case model engine 754, process engine 780, process integrator 770, and content server 750 of the case management system 700 may communicate according to almost any protocol or interface desired. For example, the content server 750 may provide one or more interfaces, such as Java APIs or the like through which may be used for communication with the content server 750 by the case model engine 754 or process engine 780.

The events may be received at the process engine 780 from the case model engine 754 based on user interactions with the case model APIs 762, received from the content server based on access (e.g., creation, update, deletion, or other access) of content (e.g., a document associated with a case model instance 754) in content server 750, received from process integrator 770 based on an occurrence of an event with respect to a LOB system 772, or received from some other source. For example, when events or other data are received from LOB systems 772 at the process integrator 770 they may be passed to the process engine 780 or other components of the case management system 700. Alternatively, or additionally, when events or data are received at the process integrator 770, the process integrator 770 may access, store, create, update, or modify (collectively store) data in repository 752 associated with case model instances 754, such as storing documents or other data associated with a particular case model instance. Based on the data stored in the repository for a case model instance 754 an event associated with the case model instance 754 may be generated for process engine 780.

When such events are received at the process engine 780, the process engine 780 can determine if the case model instance 754 associated with the received event is associated with any event rules and if any of those event rules are triggered by the received event. If an event rule has been triggered (e.g., the conditions defined by the trigger of the event rule match the features of the received event or the case model instance 754) an action defined by the triggered event rule may be taken by the process engine 780. Specifically, if the action defined by the event rule is a hierarchy related action the case engine of the process engine 780 may modify the hierarchy of the case instance 754 associated with the event in the content server 750. Such a modification may include, for example, modifying the hierarchy of the case instance 754 (e.g., such that it is different from than hierarchy as defined by an associated case model definition from which the case model instance 754 was created), including modifying the relationships between nodes of the case model instance, or adding or removing nodes (or sub-nodes) to the case model instance 754.

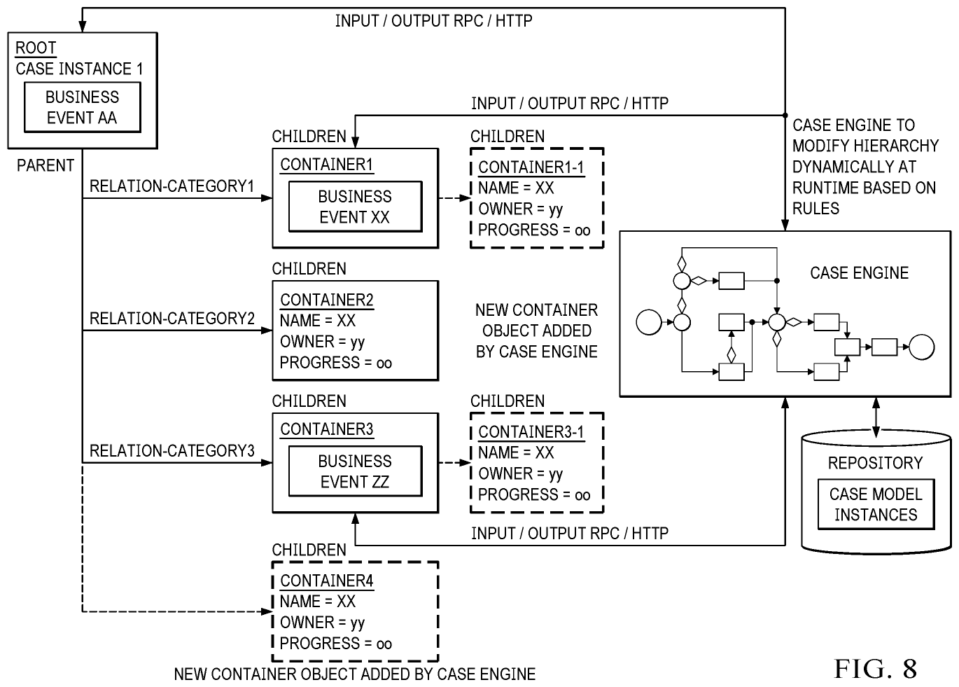

These modifications to the case model instance 754 may include modifications to the root object which is a container object and contains one or more child container objects, the child container objects or any other child container objects or other data objects, or the relationship objected relating the container objects to one another in a one-to-many relationship or other type of relationship. FIG. 8 is a block diagram representing an example of one embodiment of a modification of a set of objects for a case model instance (such as that depicted in FIG. 5) is depicted.

In this manner the hierarchy of the actual case model instances being manipulated by the case management system and undergoing workflows, lifecycles, etc. in association with case management system may have their hierarchy dynamically and independently altered during the runtime according to events specifically defined in association with that case model definition for that case model instance without either affecting the underlying case model definition itself or any other case model instances, including those case model instances created from that same case model definition. Thus, case model instances created from the same case model definition may have hierarchies different both from the original case model definition and from one another while still being managed in accordance with their association with case model definition.

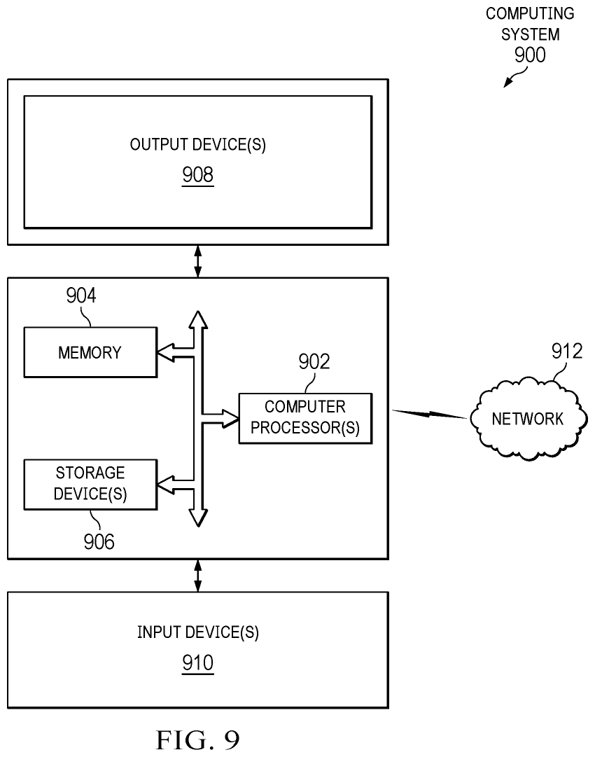

Embodiments of the technology may be implemented on a computing system. Any combination of mobile, desktop, server, embedded, or other types of hardware may be used. For example, as shown in FIG. 9, the computing system (900) may include one or more computer processor(s) (902), associated memory (904) (e.g., random access memory (RAM), cache memory, flash memory, etc.), one or more storage device(s) (906) (e.g., a hard disk, an optical drive such as a compact disk (CD) drive or digital versatile disk (DVD) drive, a flash memory stick, etc.), and numerous other elements and functionalities. The computer processor(s) (902) may be an integrated circuit for processing instructions. For example, the computer processor(s) may be one or more cores, or micro-cores of a processor. The computing system (900) may also include one or more input device(s) (910), such as a touchscreen, keyboard, mouse, microphone, touchpad, electronic pen, or any other type of input device. Further, the computing system (900) may include one or more output device(s) (908), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device(s). The computing system (900) may be connected to a network (912) (e.g., a local area network (LAN), a wide area network (WAN) such as the Internet, mobile network, or any other type of network) via a network interface connection (not shown). The input and output device(s) may be locally or remotely (e.g., via the network (912)) connected to the computer processor(s) (902), memory (904), and storage device(s) (906). Many different types of computing systems exist, and the aforementioned input and output device(s) may take other forms.

Software instructions in the form of computer readable program code to perform embodiments of the technology may be stored, in whole or in part, temporarily or permanently, on a non-transitory computer readable medium such as a CD, DVD, storage device, a diskette, a tape, flash memory, physical memory, or any other computer readable storage medium.

Specifically, the software instructions may correspond to computer readable program code that when executed by a processor(s), is configured to perform embodiments of the technology.

Further, one or more elements of the aforementioned computing system (900) may be located at a remote location and connected to the other elements over a network (912). Further, embodiments of the technology may be implemented on a distributed system having a plurality of nodes, where each portion of the technology may be located on a different node within the distributed system. In one embodiment of the technology, the node corresponds to a distinct computing device. Alternatively, the node may correspond to a computer processor with associated physical memory. The node may alternatively correspond to a computer processor or micro-core of a computer processor with shared memory and/or resources.

Although the invention has been described with respect to specific embodiments thereof, these embodiments are merely illustrative, and not restrictive of the invention. Rather, the description is intended to describe illustrative embodiments, features, and functions in order to provide a person of ordinary skill in the art context to understand the invention without limiting the invention to any particularly described embodiment, feature, or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Those skilled in the relevant art will appreciate that the invention can be implemented or practiced with other computer system configurations, including without limitation multi-processor systems, network devices, mini-computers, mainframe computers, data processors, and the like. The invention can be embodied in a computer or data processor that is specifically programmed, configured, or constructed to perform the functions described in detail herein. The invention can also be employed in distributed computing environments, where tasks or modules are performed by remote processing devices, which are linked through a communications network such as a LAN, WAN, or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks). Example chips may include Electrically Erasable Programmable Read-Only Memory (EEPROM) chips. Embodiments discussed herein can be implemented in suitable instructions that may reside on a non-transitory computer-readable medium, hardware circuitry or the like, or any combination and that may be translatable by one or more server machines.

ROM, RAM, and HD are computer memories for storing computer-executable instructions executable by the CPU or capable of being compiled or interpreted to be executable by the CPU. Suitable computer-executable instructions may reside on a computer-readable medium (e.g., ROM, RAM, or HD), hardware circuitry or the like, or any combination thereof. Within this disclosure, the term “computer-readable medium” is not limited to ROM, RAM, and HD and can include any type of data storage medium that can be read by a processor. For example, a computer-readable medium may refer to a data cartridge, a data backup magnetic tape, a floppy diskette, a flash memory drive, an optical data storage drive, a CD-ROM, ROM, RAM, HD, or the like. The processes described herein may be implemented in suitable computer-executable instructions that may reside on a computer-readable medium (for example, a disk, CD-ROM, a memory, etc.). Alternatively, the computer-executable instructions may be stored as software code components on a direct access storage device array, magnetic tape, floppy diskette, optical storage device, or other appropriate computer-readable medium or storage device.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Any suitable programming language can be used to implement the routines, methods or programs of embodiments of the invention described herein, including C, C++, Java, JavaScript, HTML, or any other programming or scripting code, etc. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps, and operations described herein can be performed in hardware, software, firmware, or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways or methods to implement the invention.

It is also within the spirit and scope of the invention to implement in software programming or code any of the steps, operations, methods, routines or portions thereof described herein, where such software programming or code can be stored in a computer-readable medium and can be operated on by a processor to permit a computer to perform any of the steps, operations, methods, routines or portions thereof described herein. In general, the functions of the invention can be achieved by, for example, distributed, or networked systems, components, and circuits. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system, or device. The computer-readable medium can be, by way of example only but not by limitation, an electronic, magnetic, optical, electromagnetic, infrared, or semiconductor system, apparatus, system, device, propagation medium, or computer memory. Such a computer-readable medium shall generally be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer-readable media storing computer instructions translatable by one or more processors in a computing environment.

It will also be appreciated that one or more of the elements depicted in the drawings/figures can be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited to only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, including the claims that follow, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the claims that follow, the meaning of “in” includes “in” and “on” unless the context clearly dictates otherwise. The scope of the present disclosure should be determined by the following claims and their legal equivalents.

What is claimed:

1. A method for providing dynamic case instances in a case management system, the method comprising:
obtaining a case model definition including a definition of a plurality of nodes arranged according to a first hierarchy, each node associated with a hierarchical level in the first hierarchy, wherein the case model definition is associated with an alteration rule, the alteration rule comprising a trigger including a condition and an associated configuration definition;
creating a first case model instance from the case model definition, wherein the first case model instance comprises a first set of nodes, each of the first set of nodes associated with a corresponding one of the plurality of nodes of the case model definition and arranged according to the first hierarchy defined in the case model definition;
creating a second case model instance from the case model definition, wherein the second case model instance comprises a second set of nodes, each of the second set of nodes associated with the corresponding one of the plurality of nodes of the case model definition and arranged according to the first hierarchy defined in the case model definition;
receiving an event associated with the first case model instance;
determining the first case model instance is associated with the alteration rule based on the case model definition;
comparing the event to the trigger;
based on the event meeting the trigger of the alteration rule associated with the first case model, dynamically reconfiguring the first set of nodes of the first case model such that the first set of nodes of the first case model instance are arranged according to a second hierarchy while the second set of nodes of the second case model instance remain configured according to the first hierarchy defined in the case model definition.

2. The method of claim 1, wherein the first case model instance comprises an in memory runtime case model instance and a corresponding data store case model instance and dynamically reconfiguring the first set of nodes comprises reconfiguring the runtime case model instance and, based on the reconfiguring of the runtime case model instance, reconfiguring the corresponding data store case model instance in accordance with the runtime case model instance.

3. The method of claim 1, wherein the alteration rule is associated with a node of the plurality of nodes of the definition, and dynamically reconfiguring the first set of nodes comprises reconfiguring a relationship of the corresponding node of the first set of nodes to one or more of the other nodes of the first set of nodes.

4. The method of claim 3, wherein reconfiguring the relationship changes the hierarchical level of the corresponding node of the first set of nodes.

5. The method of claim 1, wherein dynamically reconfiguring the first set of nodes comprises deleting or adding a node to the first set of nodes.

6. The method of claim 1, wherein the first case model instance and the second case model instance are maintained in a content management system.

7. The method of claim 1, wherein the event is generated based on the creation or update of a document in the content management system.

8. A case management system providing dynamic case instances, comprising:
a processor; and
a non-transitory computer readable storage medium comprising instructions for:
obtaining a case model definition including a definition of a plurality of nodes arranged according to a first hierarchy, each node associated with a hierarchical level in the first hierarchy, wherein the case model definition is associated with an alteration rule, the alteration rule comprising a trigger including a condition and an associated configuration definition;
creating a first case model instance from the case model definition, wherein the first case model instance comprises a first set of nodes, each of the first set of nodes associated with a corresponding one of the plurality of nodes of the case model definition and arranged according to the first hierarchy defined in the case model definition;
creating a second case model instance from the case model definition, wherein the second case model instance comprises a second set of nodes, each of the second set of nodes associated with the corresponding one of the plurality of nodes of the case model definition and arranged according to the first hierarchy defined in the case model definition;
receiving an event associated with the first case model instance;
determining the first case model instance is associated with the alteration rule based on the case model definition;
comparing the event to the trigger; and
based on the event meeting the trigger of the alteration rule associated with the first case model, dynamically reconfiguring the first set of nodes of the first case model such that the first set of nodes of the first case model instance are arranged according to a second hierarchy while the second set of nodes of the second case model instance remain configured according to the first hierarchy defined in the case model definition.

9. The case management system of claim 8, wherein the first case model instance comprises an in memory runtime case model instance and a corresponding data store case model instance and dynamically reconfiguring the first set of nodes comprises reconfiguring the runtime case model instance and, based on the reconfiguring of the runtime case model instance, reconfiguring the corresponding data store case model instance in accordance with the runtime case model instance.

10. The case management system of claim 8, wherein the alteration rule is associated with a node of the plurality of nodes of the definition, and dynamically reconfiguring the first set of nodes comprises reconfiguring a relationship of the corresponding node of the first set of nodes to one or more of the other nodes of the first set of nodes.

11. The case management system of claim 10, wherein reconfiguring the relationship changes the hierarchical level of the corresponding node of the first set of nodes.

12. The case management system of claim 8, wherein dynamically reconfiguring the first set of nodes comprises deleting or adding a node to the first set of nodes.

13. The case management system of claim 8, wherein the first case model instance and the second case model instance are maintained in a content management system.

14. The case management system of claim 8, wherein the event is generated based on the creation or update of a document in the content management system.

15. A non-transitory computer readable medium, comprising instructions for:
obtaining a case model definition including a definition of a plurality of nodes arranged according to a first hierarchy, each node associated with a hierarchical level in the first hierarchy, wherein the case model definition is associated with an alteration rule, the alteration rule comprising a trigger including a condition and an associated configuration definition;
creating a first case model instance from the case model definition, wherein the first case model instance comprises a first set of nodes, each of the first set of nodes associated with a corresponding one of the plurality of nodes of the case model definition and arranged according to the first hierarchy defined in the case model definition;
creating a second case model instance from the case model definition, wherein the second case model instance comprises a second set of nodes, each of the second set of nodes associated with the corresponding one of the plurality of nodes of the case model definition and arranged according to the first hierarchy defined in the case model definition;
receiving an event associated with the first case model instance;
determining the first case model instance is associated with the alteration rule based on the case model definition;
comparing the event to the trigger;
based on the event meeting the trigger of the alteration rule associated with the first case model, dynamically reconfiguring the first set of nodes of the first case model such that the first set of nodes of the first case model instance are arranged according to a second hierarchy while the second set of nodes of the second case model instance remain configured according to the first hierarchy defined in the case model definition.

16. The non-transitory computer readable medium of claim 15, wherein the first case model instance comprises an in memory runtime case model instance and a corresponding data store case model instance and dynamically reconfiguring the first set of nodes comprises reconfiguring the runtime case model instance and, based on the reconfiguring of the runtime case model instance, reconfiguring the corresponding data store case model instance in accordance with the runtime case model instance.

17. The non-transitory computer readable medium of claim 15, wherein the alteration rule is associated with a node of the plurality of nodes of the definition, and dynamically reconfiguring the first set of nodes comprises reconfiguring a relationship of the corresponding node of the first set of nodes to one or more of the other nodes of the first set of nodes.

18. The non-transitory computer readable medium of claim 17, wherein reconfiguring the relationship changes the hierarchical level of the corresponding node of the first set of nodes.

19. The non-transitory computer readable medium of claim 15, wherein dynamically reconfiguring the first set of nodes comprises deleting or adding a node to the first set of nodes.

20. The non-transitory computer readable medium of claim 15, wherein the first case model instance and the second case model instance are maintained in a content management system.

21. The non-transitory computer readable medium of claim 15, wherein the event is generated based on the creation or update of a document in the content management system.
